(19) United States
(12) Patent Application Publication
(10) Pub. No.: US 2017/0020786 A1
(43) Pub. Date: Jan. 26, 2017

(54) ELECTROLYTE CAPSULE DISPENSER

(71) Applicant: Juan Carlos Villa Solano, Miami, FL (US)

(72) Inventor: Juan Carlos Villa Solano, Miami, FL (US)

(21) Appl. No.: 15/216,323

(22) Filed: Jul. 21, 2016

Related U.S. Application Data
(60) Provisional application No. 62/195,042, filed on Jul. 21, 2015.

(51) Int. Cl. A61J 7/04; B65D 83/04; A61J 7/00

(52) U.S. Cl. CPC A61J 7/0472; A61J 7/0076; B65D 83/0409

(57) ABSTRACT

A system is delineated for dispensing capsules used to provide desired material to a user engaged in activity, athletic or otherwise. The system may include a housing and a magazine slideably retained within the housing, wherein the magazine is for retaining provided capsules for selective dispensing from the housing. The system may also include a timer for counting down a predetermined time period and an indicator for signifying to a user when the predetermined time period has run, indicating that it is time to dispense and consume one of the provided capsules.

### CROSS REFERENCE TO RELATED APPLICATION

This application is related to and claims priority from U.S. Appl. No. 62/195,042, filed on Jul. 21, 2015 and entitled “ELECTROLYTE CAPSULE DISPENSER” in the name of the same inventor, the content of which is hereby incorporated herein by reference in its entirety.

### BACKGROUND OF THE INVENTION

Field of the Invention

The present invention relates to dispensers, and more particularly, to systems and methods for providing an electrolyte capsule dispenser.

Description of the Related Art

While undertaking physical activities (athletic or otherwise), especially strenuous activities, the body loses key nutrients. These nutrients can be replenished while undergoing the physical activity by ingesting capsules and at the correct times. Science suggests that providing the body with electrolytes and liquids at optimal time intervals maximizes performance. Dehydration of 2% can amount to a 30% loss in physical performance.

There are various types and brands of capsules with various purposes, such as electrolyte replacement, anti-cramping, energy boost, etc. The problem is that there are no ideal solutions for professional athletes, recreational athletes, trail runners, bikers, marathoners, enthusiasts, etc., to carry and dispense capsules while racing or training.

Typically capsules are consumed as follows:
A. Ziplock Bacmies: This is a poor solution since the consumer has to take the bag out of pocket or backpack while on the go, pick out the capsule (e.g., electrolyte, anti-cramping, etc.), take out the capsule, and in the process touch other capsules with sweat making them sticky, and put the bag away. This process is very difficult to do on a bike without stopping.
B. M&M Plastic Bottle with a Top: This is arguably a better solution than process A above, but the runner, biker, etc., has to shake out a capsule into the mouth and negotiate that only one comes out. The consumer also has to shake the bottle to get the right capsule to suit the purpose at the moment.
C. SaltStick: This approach involves a long tube with a twisting end that feeds out one capsule at a time. Two hands are needed, one to hold and one to twist out the capsule. It also can be used on a bike bar. It means twisting on the go and looking down to see when enough of the capsule is exposed.

Thus, a need exists for systems and methods, which overcome these and other problems.

### SUMMARY OF THE INVENTION

In accordance with one embodiment of the invention, a system is disclosed for dispensing capsules to a user involved in an activity, athletic or otherwise. The system may include a housing; a magazine slideably retained within the housing, said magazine for retaining provided capsules for selective dispensing from the housing; a timer for counting down a predetermined time period; and an indicator for signifying to a user when the predetermined time period has run, indicating that it is time to dispense and consume one of the provided capsules.

In accordance with another embodiment of the invention, a method is disclosed for dispensing capsules to a user involved in an activity, athletic or otherwise. The method may include providing a housing; providing a magazine slideably retained within the housing, said magazine for retaining provided capsules for selective dispensing from the housing; counting down a predetermined time period; and signifying to a user when the predetermined time period has run, indicating that it is time to dispense and consume one of the provided capsules.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a perspective view showing certain components of a dispenser embodiment, in accordance with systems and methods consistent with the present invention.

FIG. 2 is a perspective view showing certain components of a dispenser embodiment, in accordance with systems and methods consistent with the present invention.

FIG. 3 is a perspective view showing certain components of a dispenser embodiment, in accordance with systems and methods consistent with the present invention.

FIGS. 4-11 depict a method for loading a dispenser embodiment, in accordance with systems and methods consistent with the present invention.

FIG. 12 is a perspective view showing certain components of a dispenser embodiment, in accordance with systems and methods consistent with the present invention.

FIGS. 13-14 are perspective views showing a dispenser embodiment with a water shield in a closed and an open configuration, respectively, in accordance with systems and methods consistent with the present invention.

FIG. 15 illustrates both a perspective view and a side elevational view of a dispenser embodiment, in accordance with systems and methods consistent with the present invention.

FIG. 16 illustrates side-by-side perspective views of opposing sides of a dispenser embodiment, in accordance with systems and methods consistent with the present invention.

FIG. 17 illustrates side-by-side perspective views of opposing sides of a dispenser embodiment, in accordance with systems and methods consistent with the present invention.

FIG. 18 illustrates side-by-side perspective views of opposing sides of a dispenser embodiment, in accordance with systems and methods consistent with the present invention.

FIG. 19 illustrates side-by-side perspective views of opposing sides of a dispenser embodiment, in accordance with systems and methods consistent with the present invention.

FIGS. 20-25 show a variety of different perspective views, with certain parts transparent to show components of a dispenser embodiment, in accordance with systems and methods consistent with the present invention.

FIG. 26 show a plan view of components for a dispenser embodiment, in accordance with systems and methods consistent with the present invention.

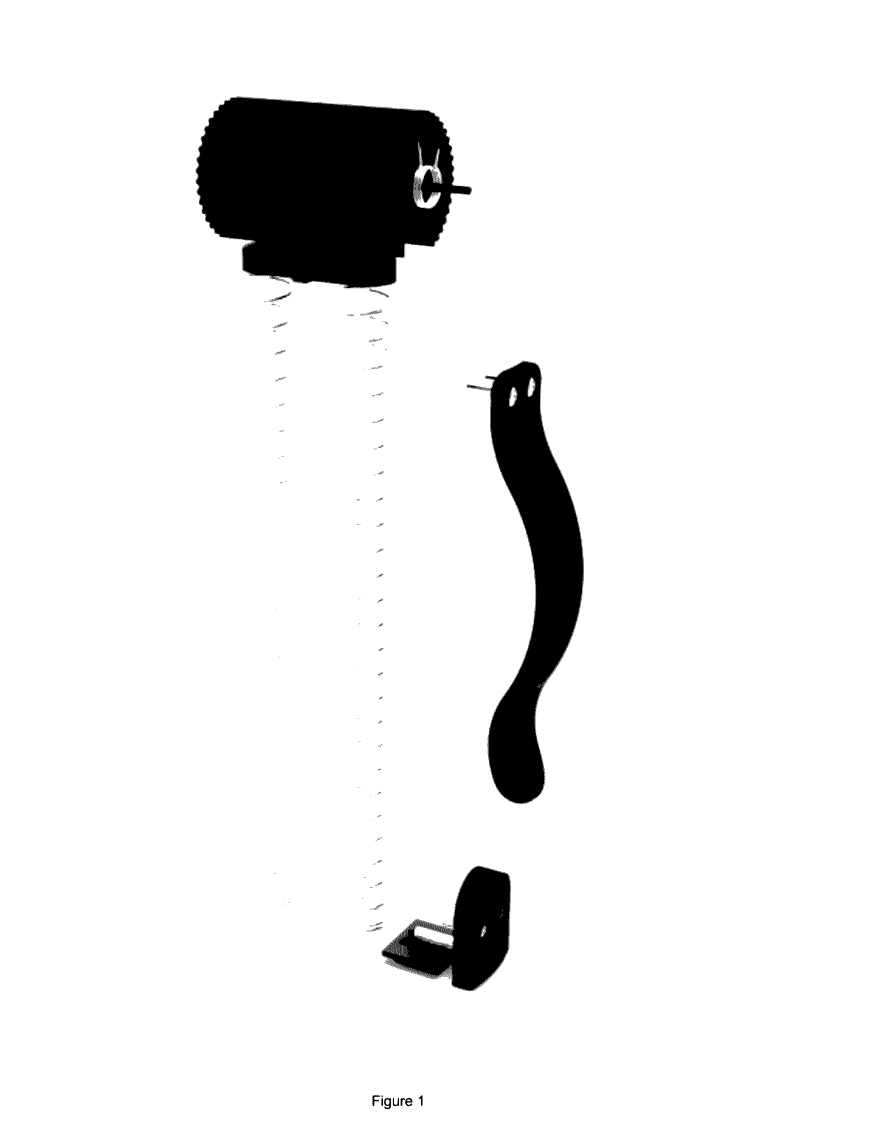

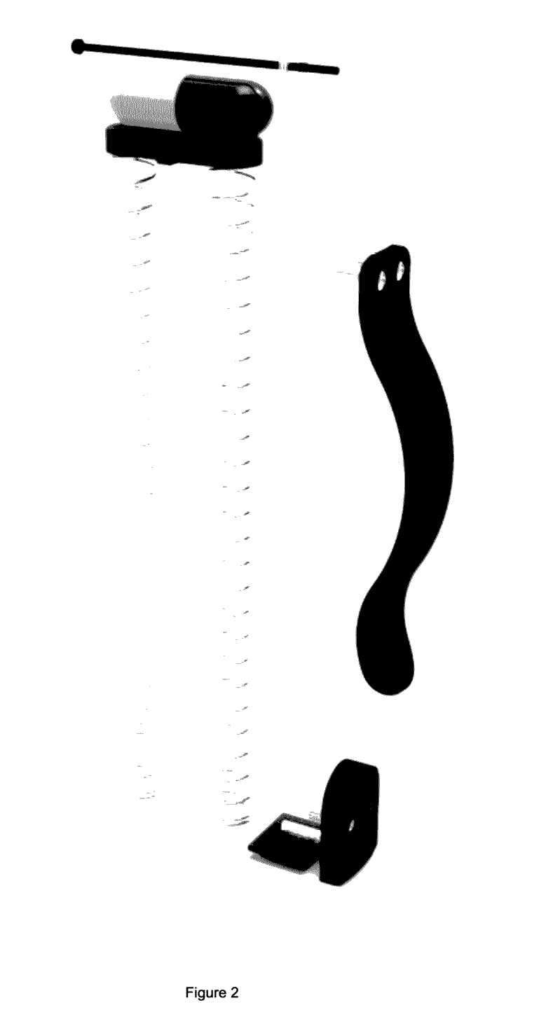

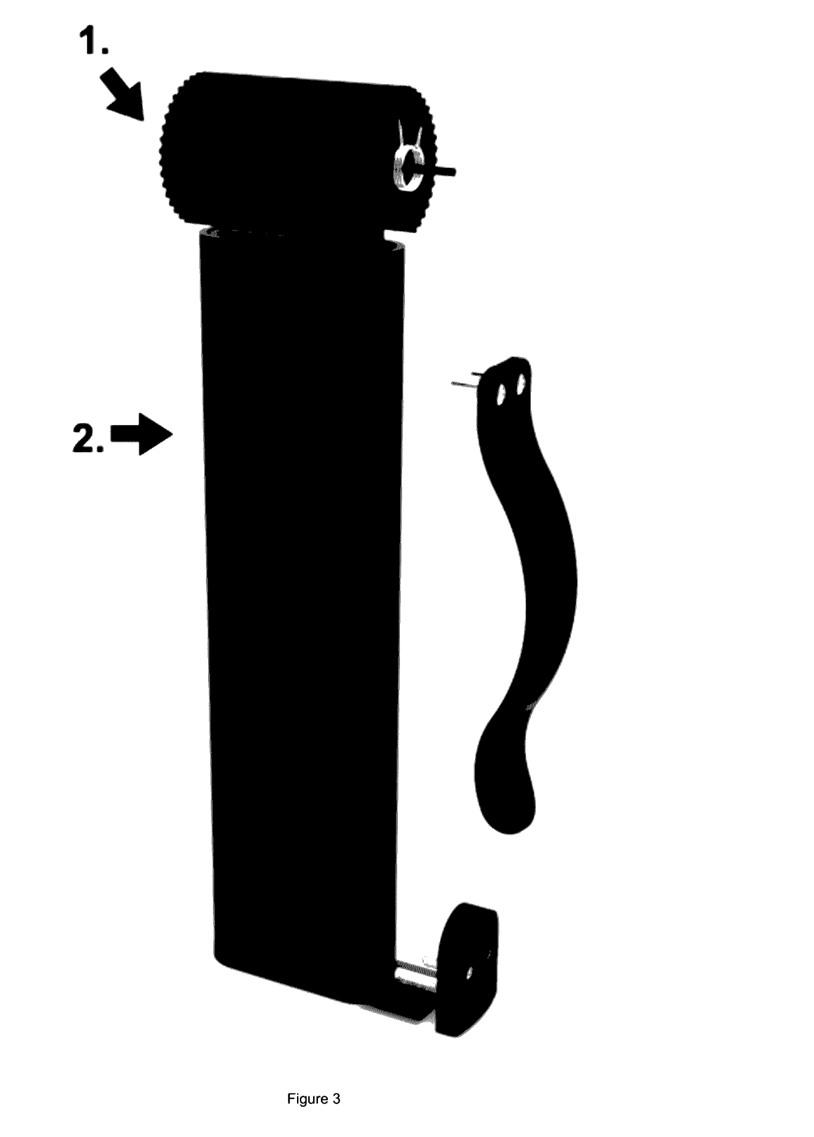

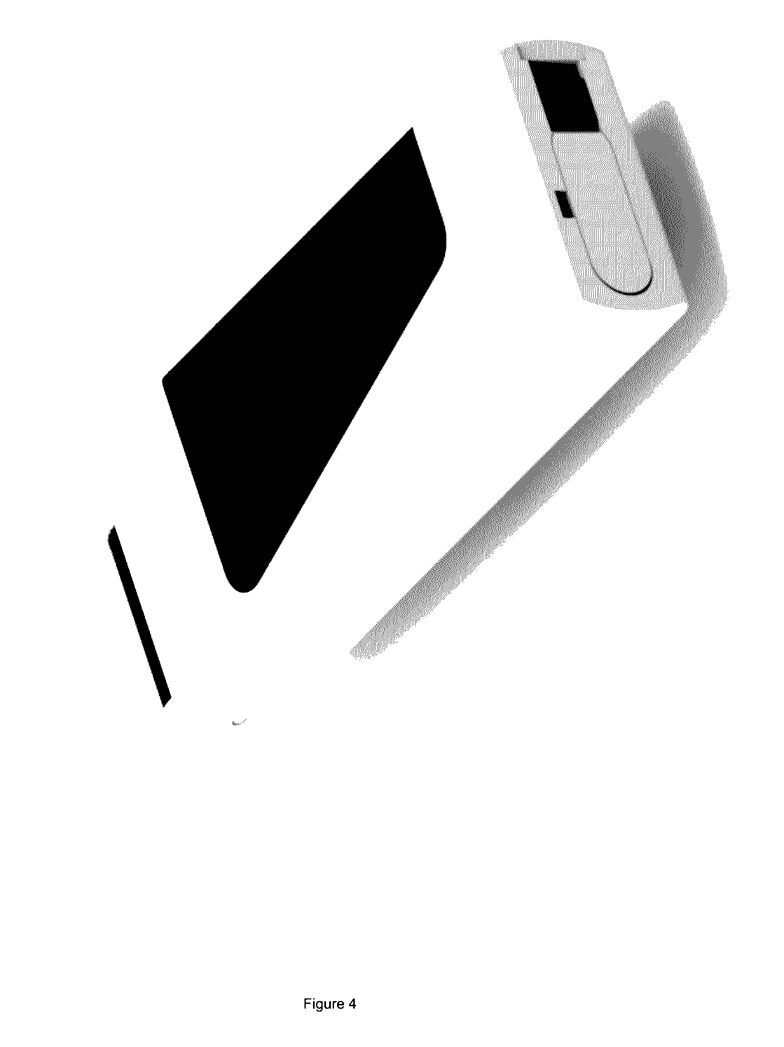

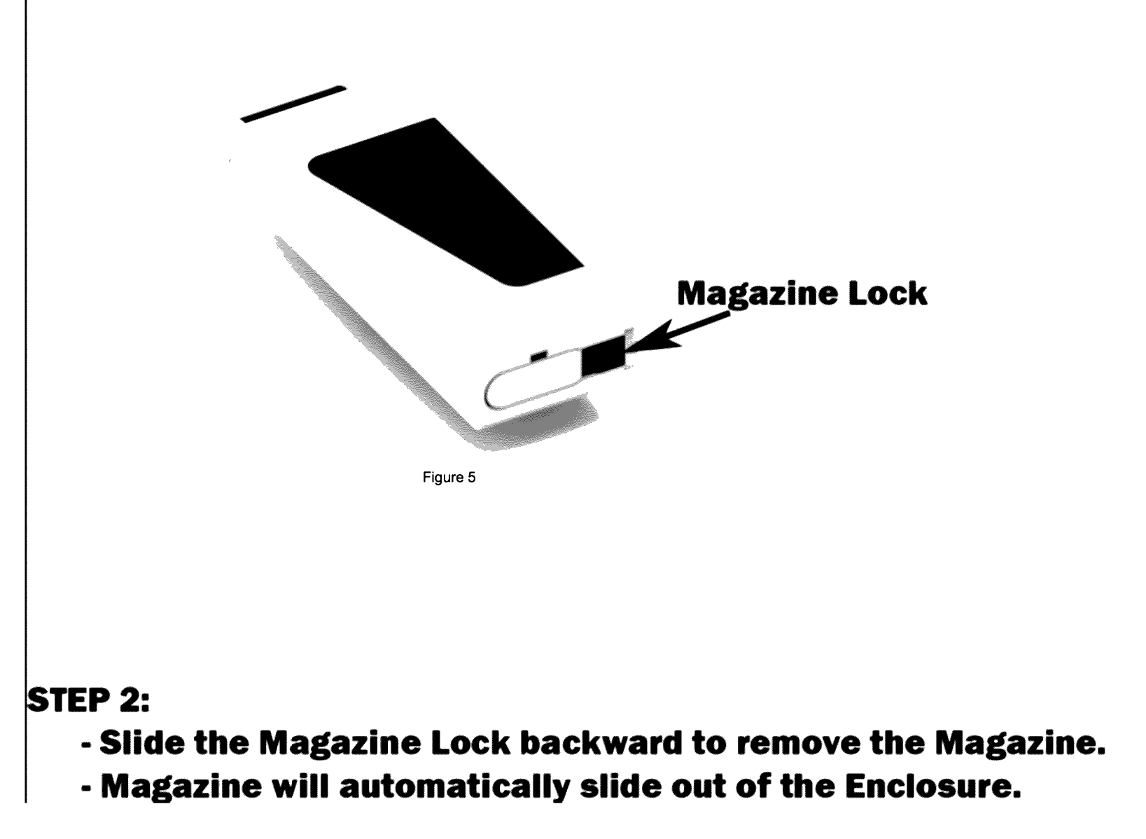

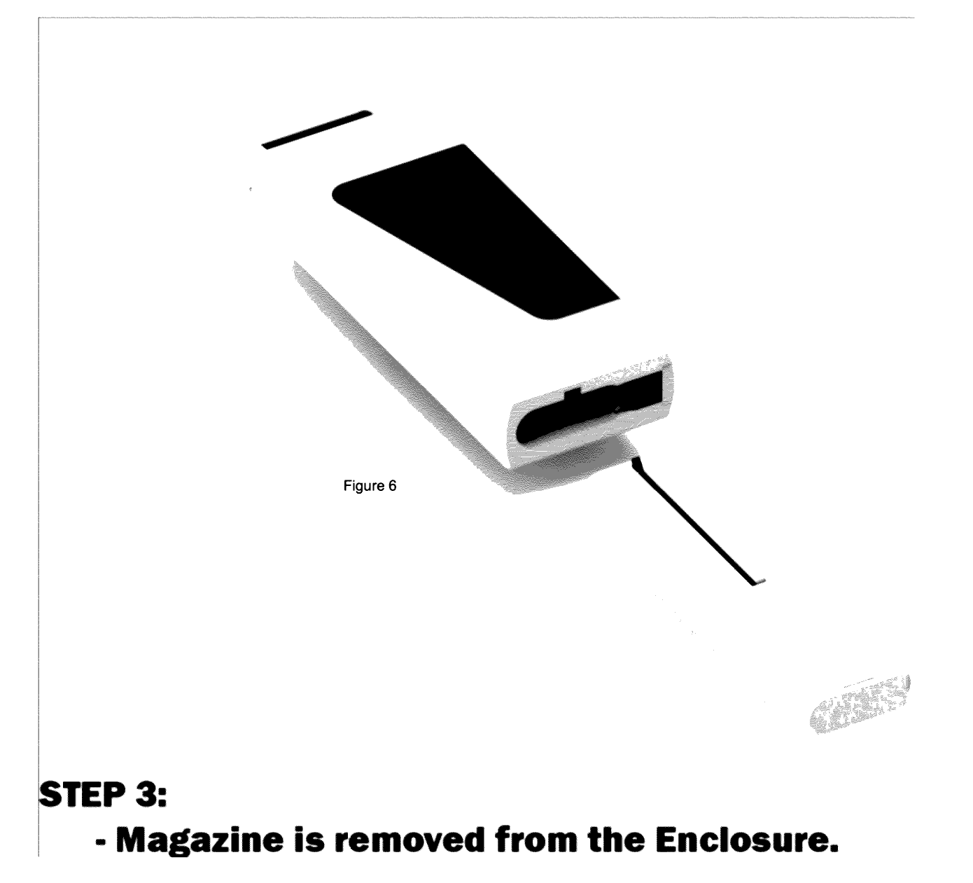

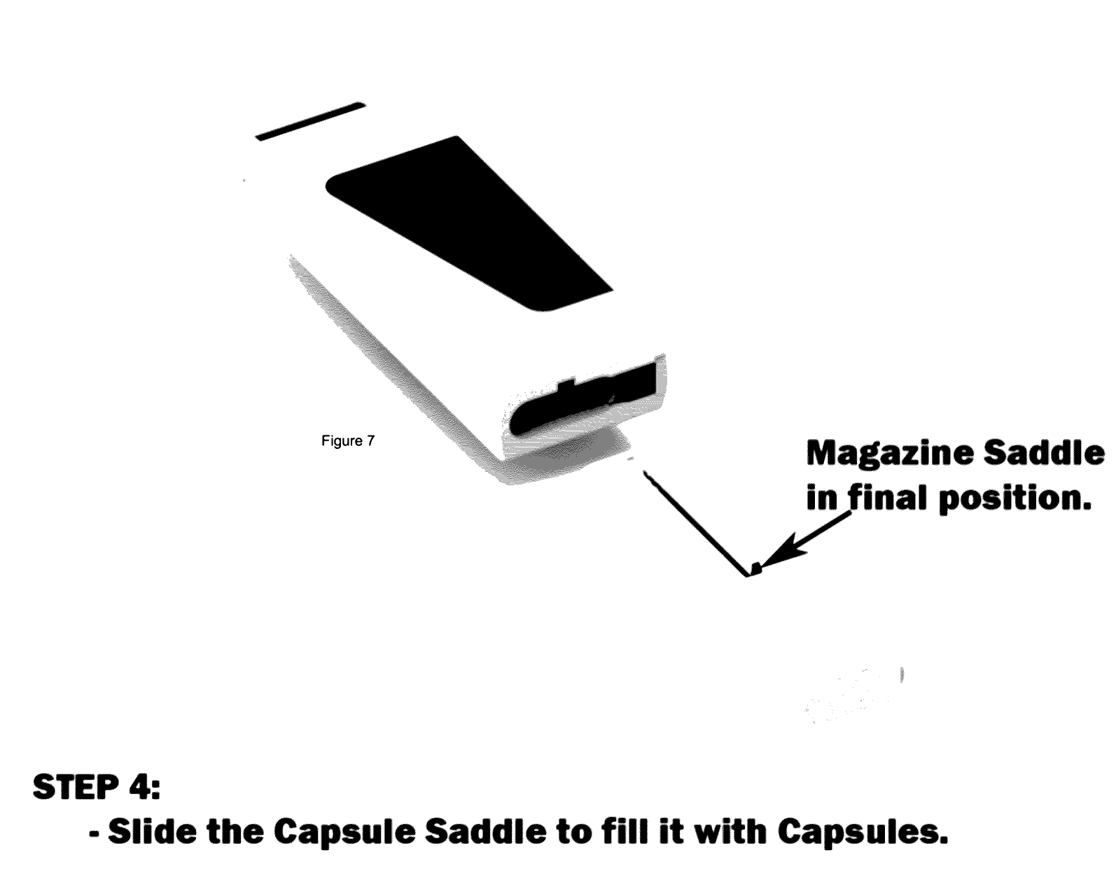

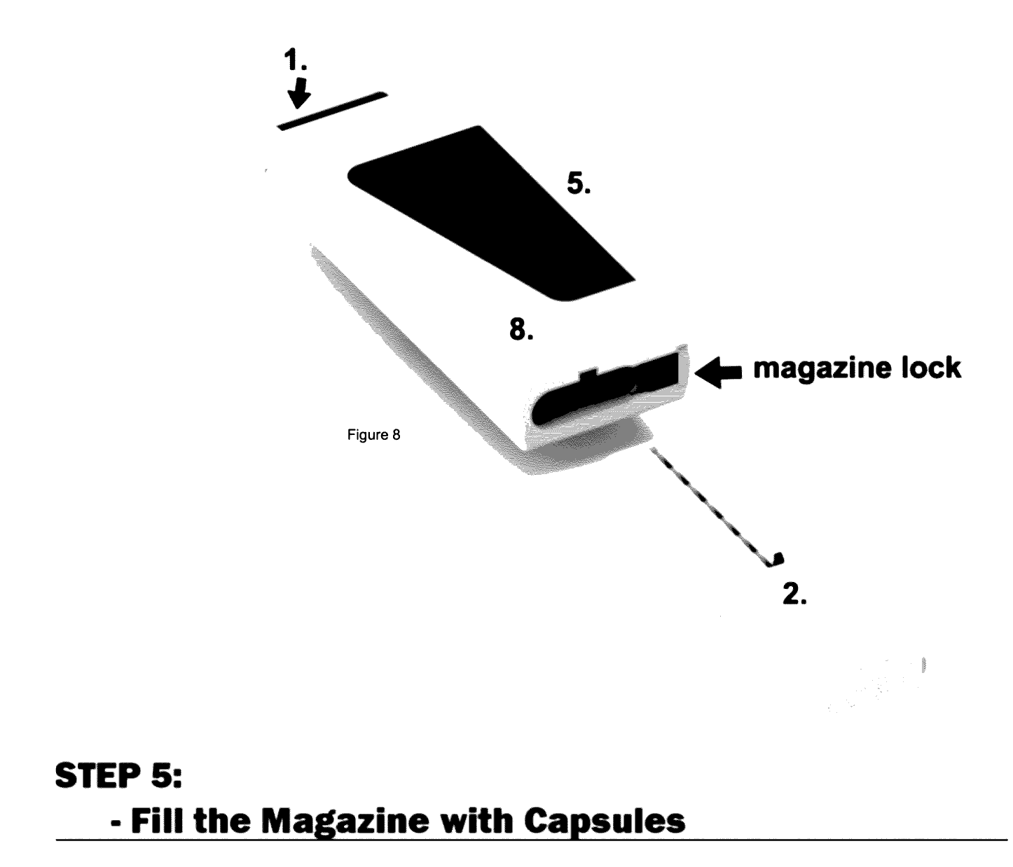

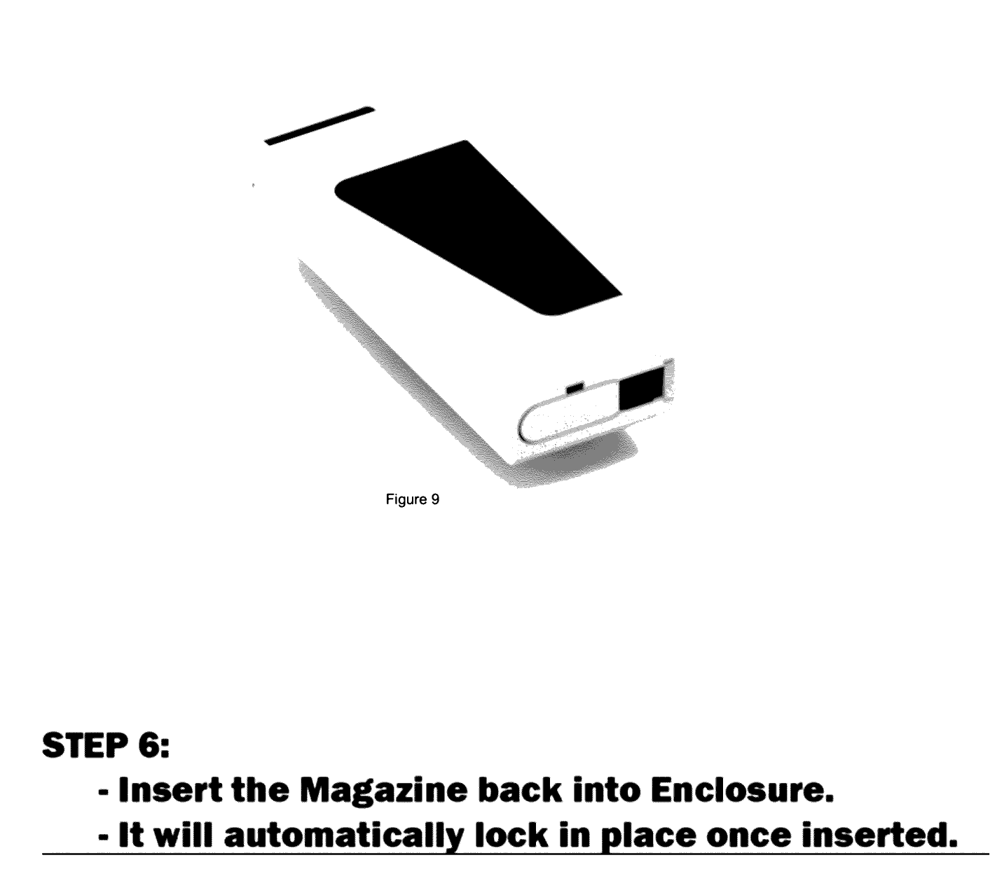

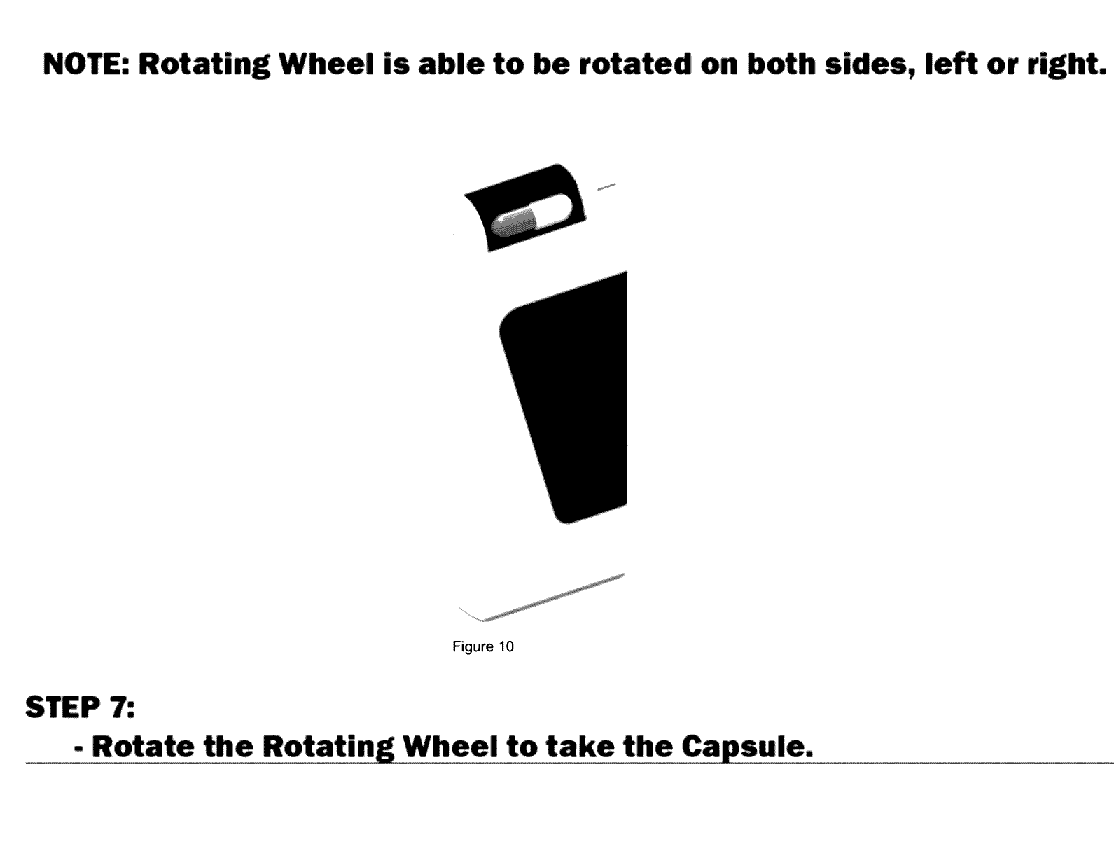

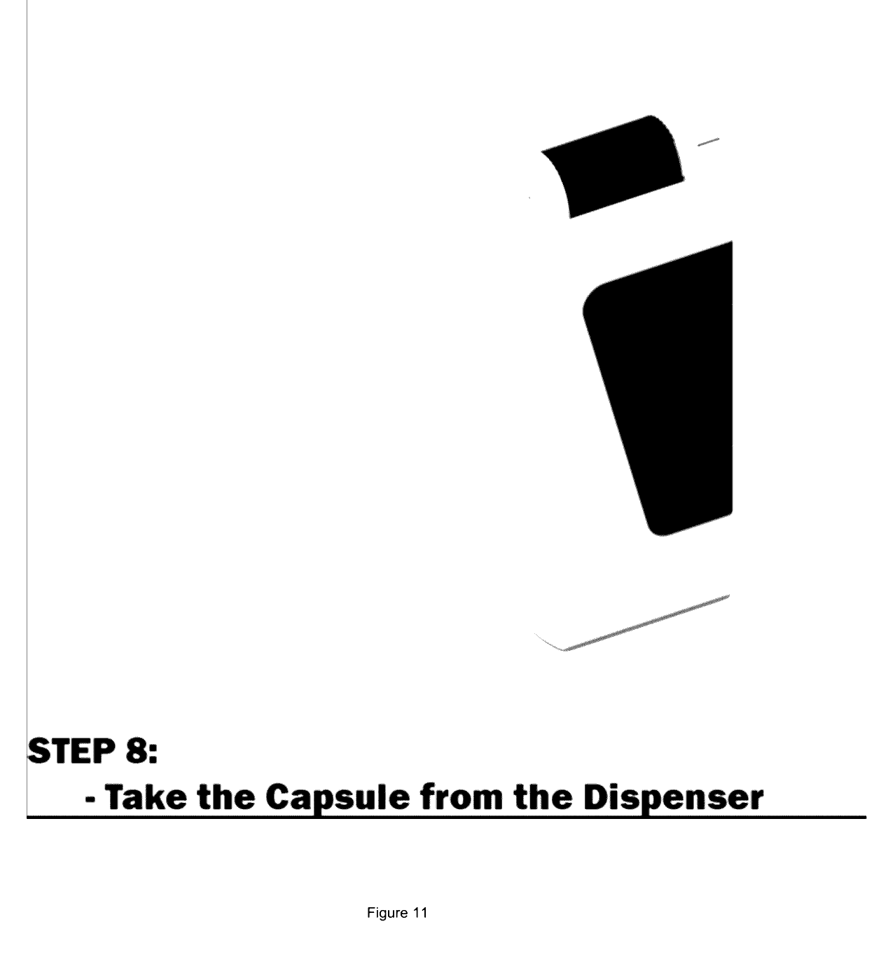

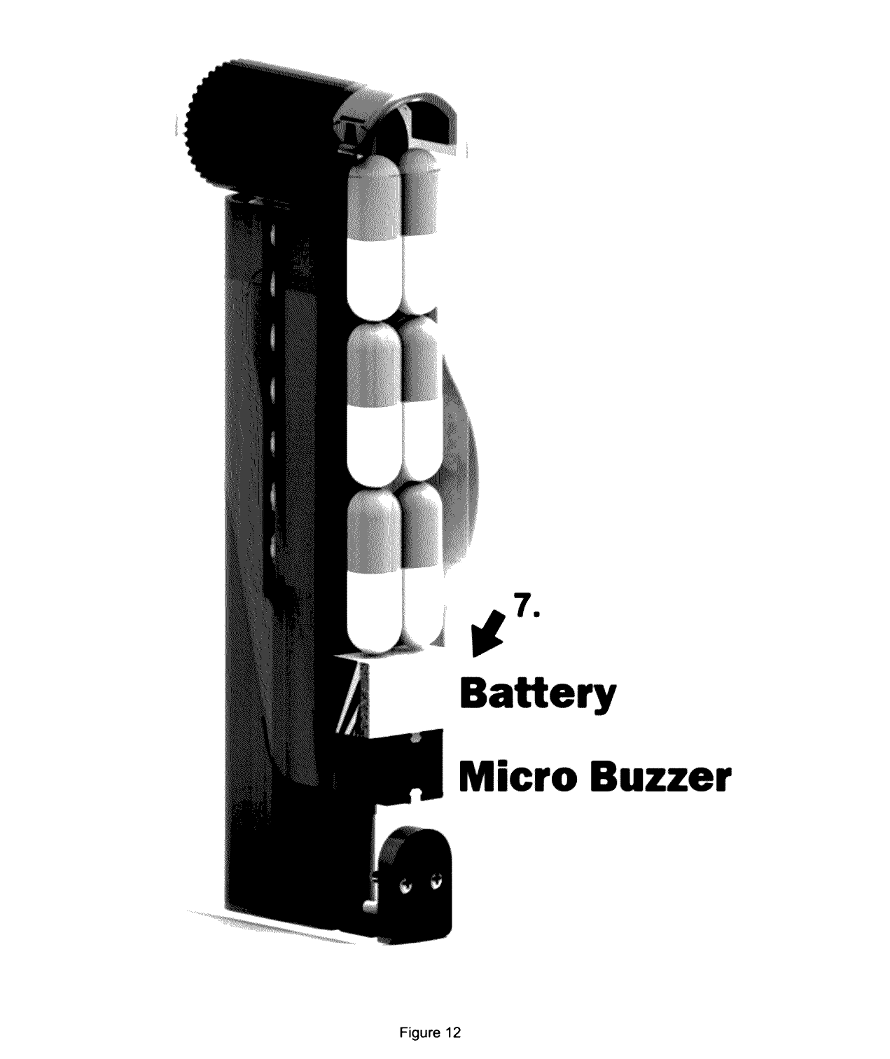

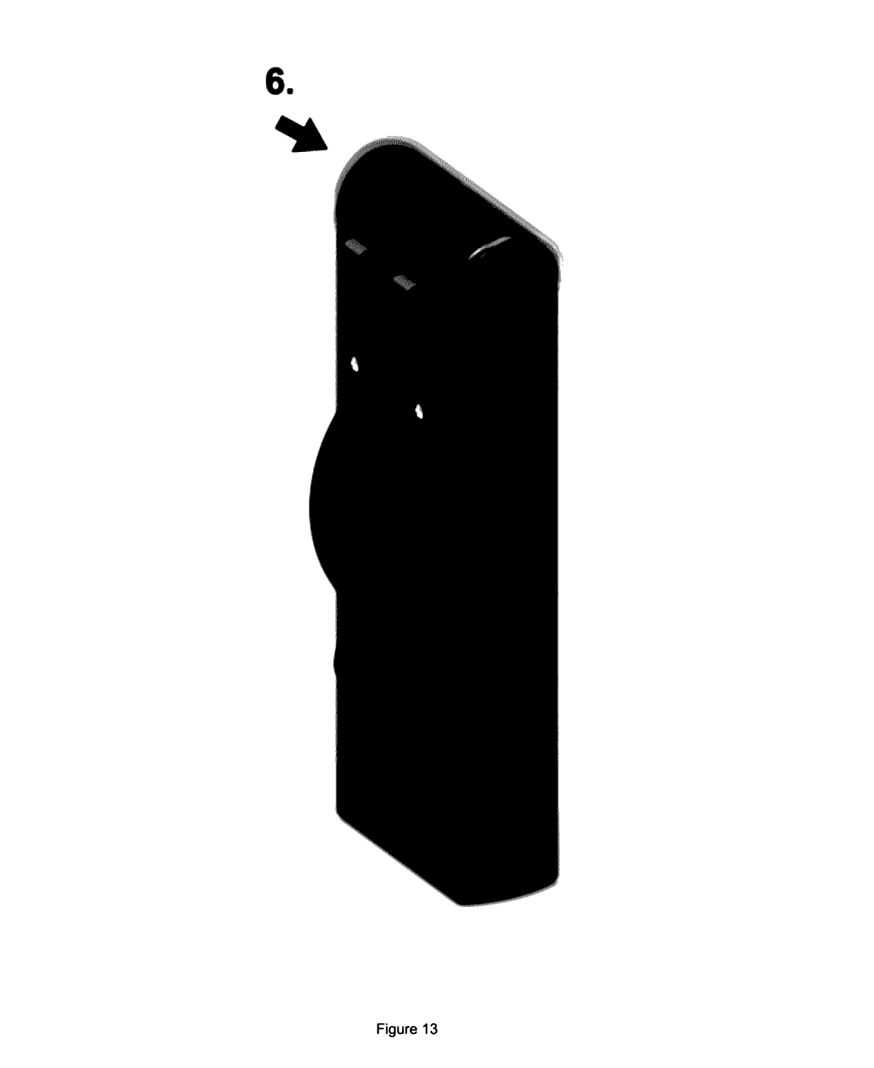

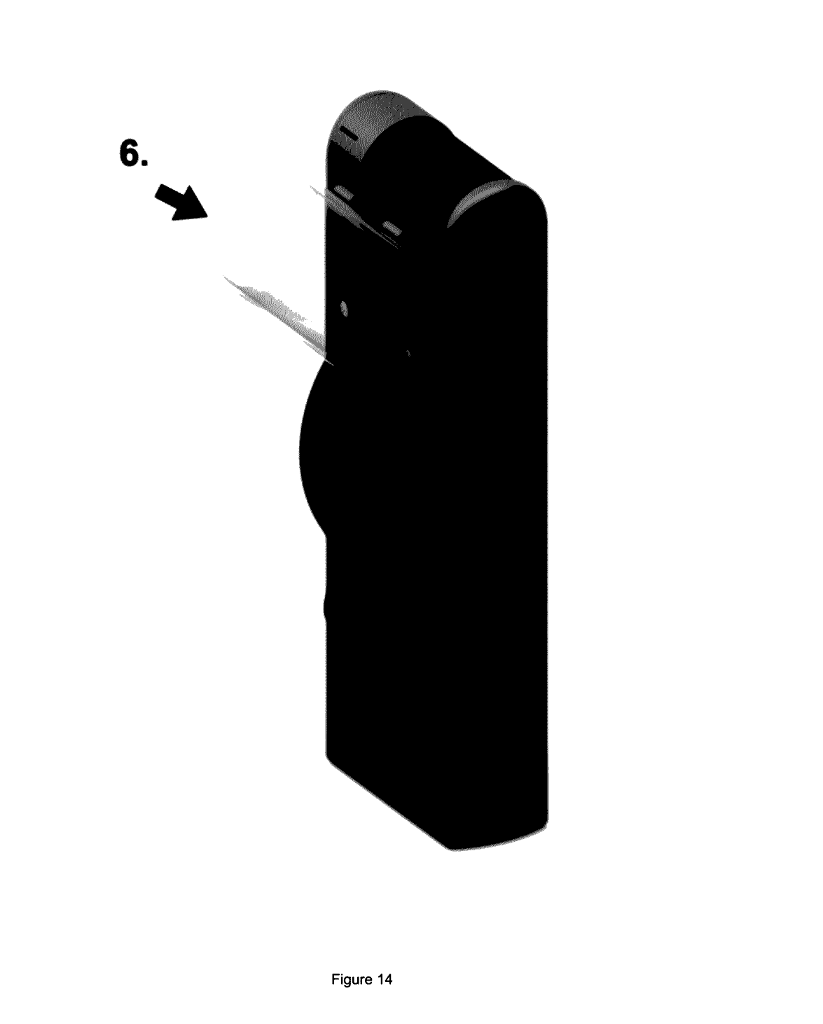

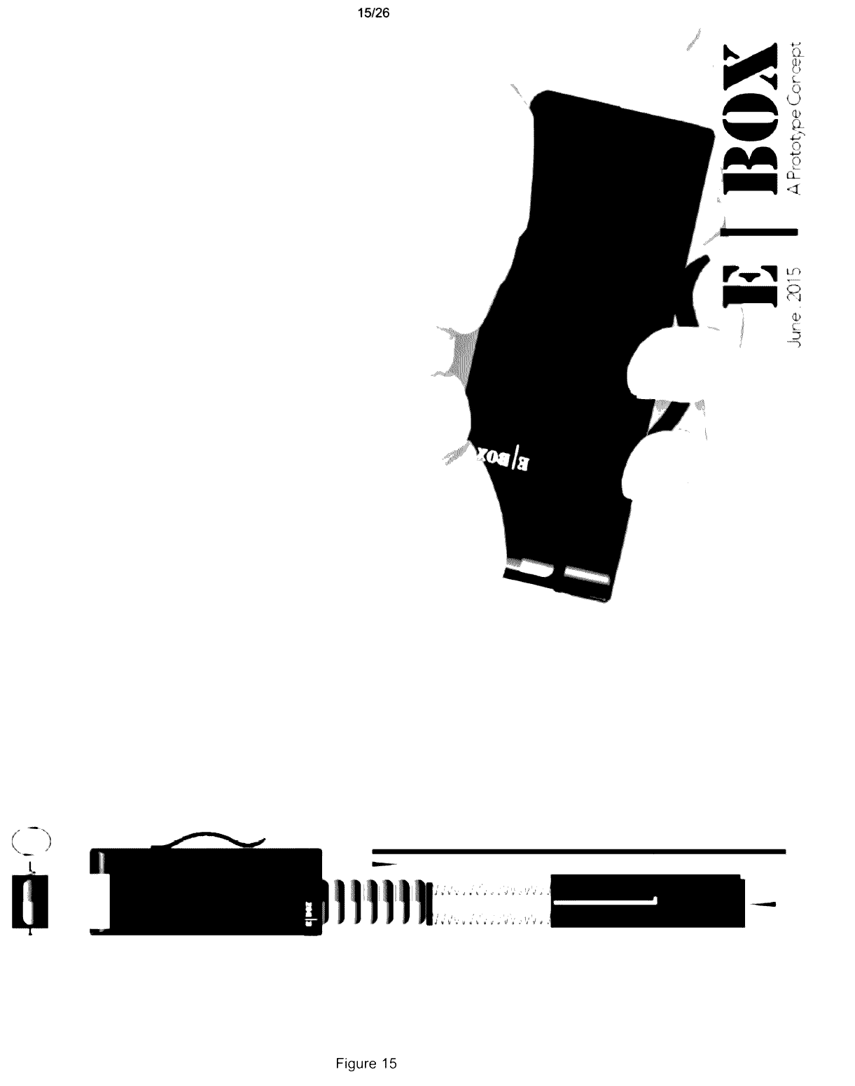

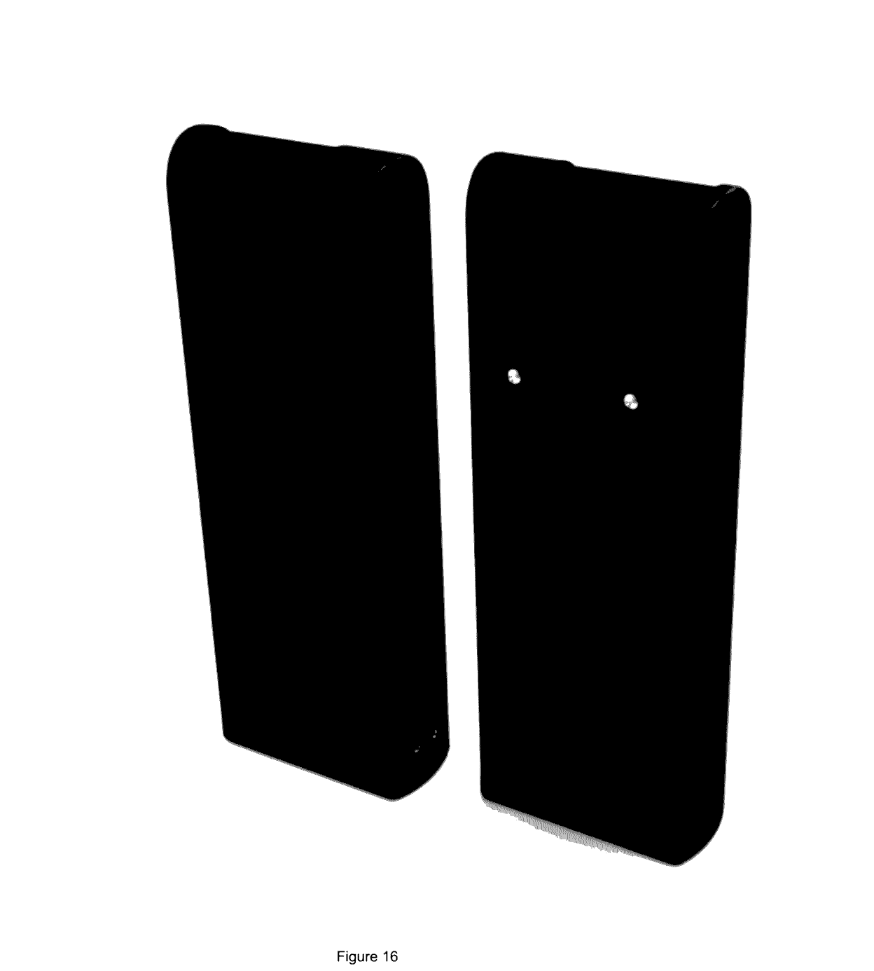

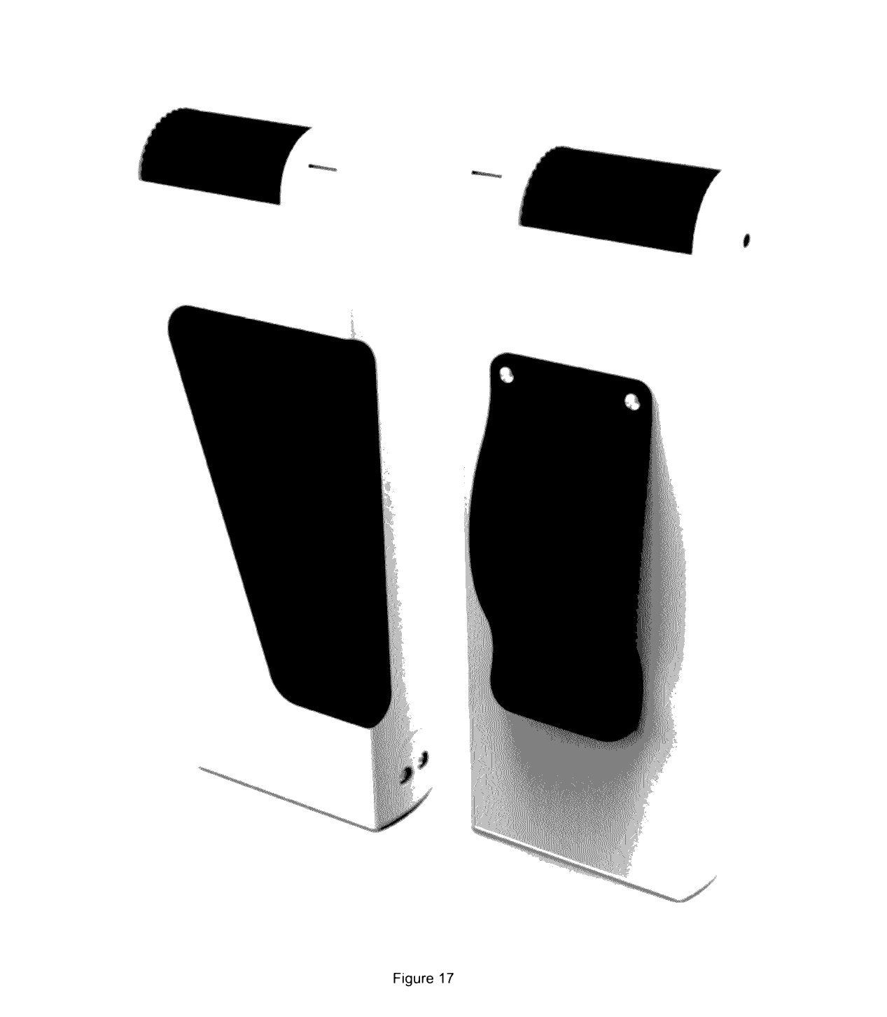

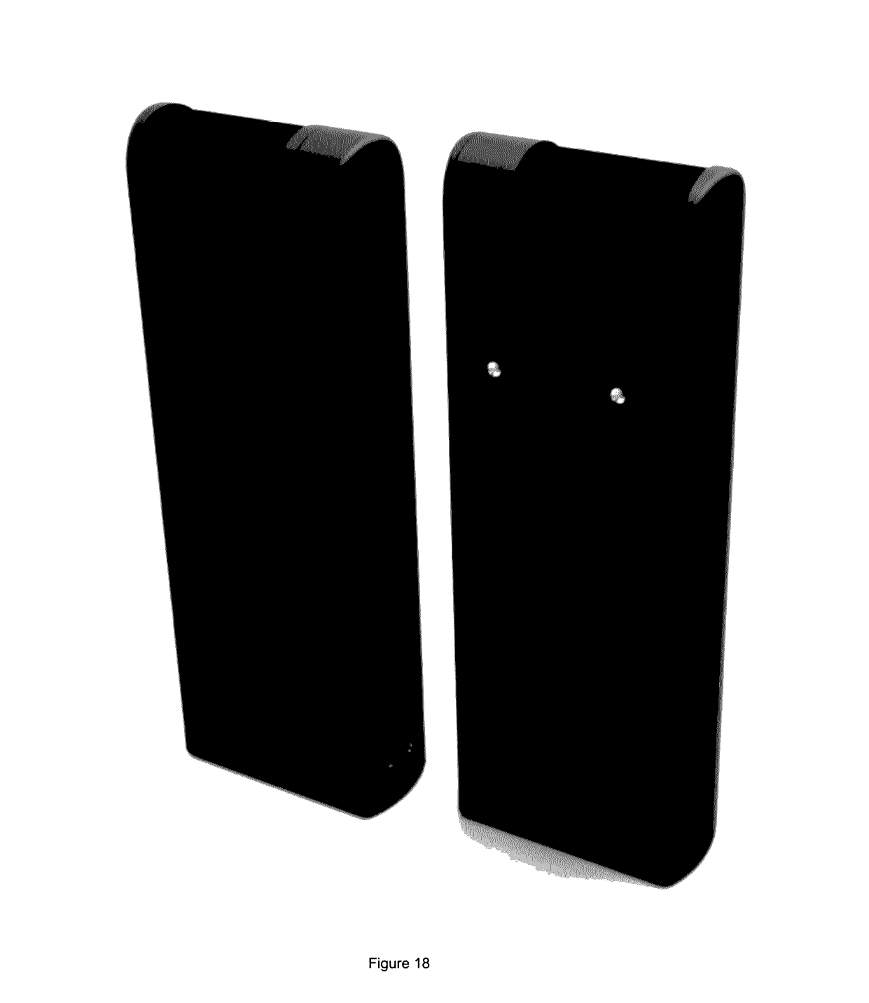

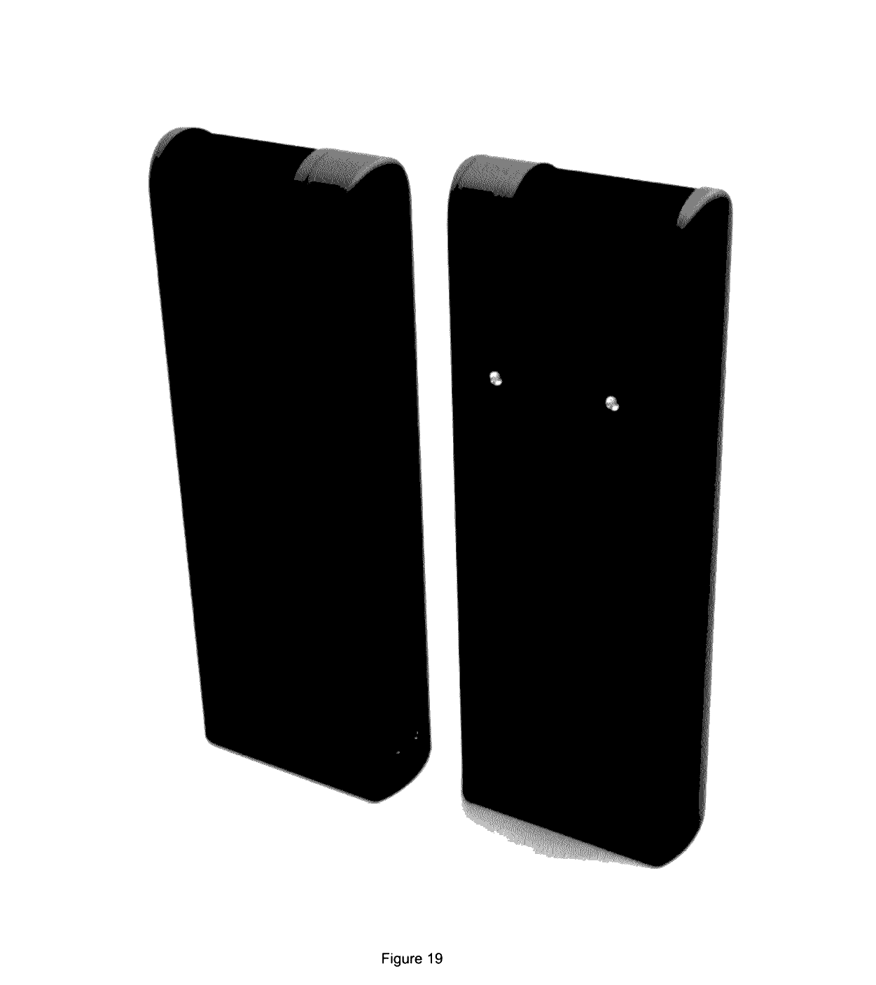

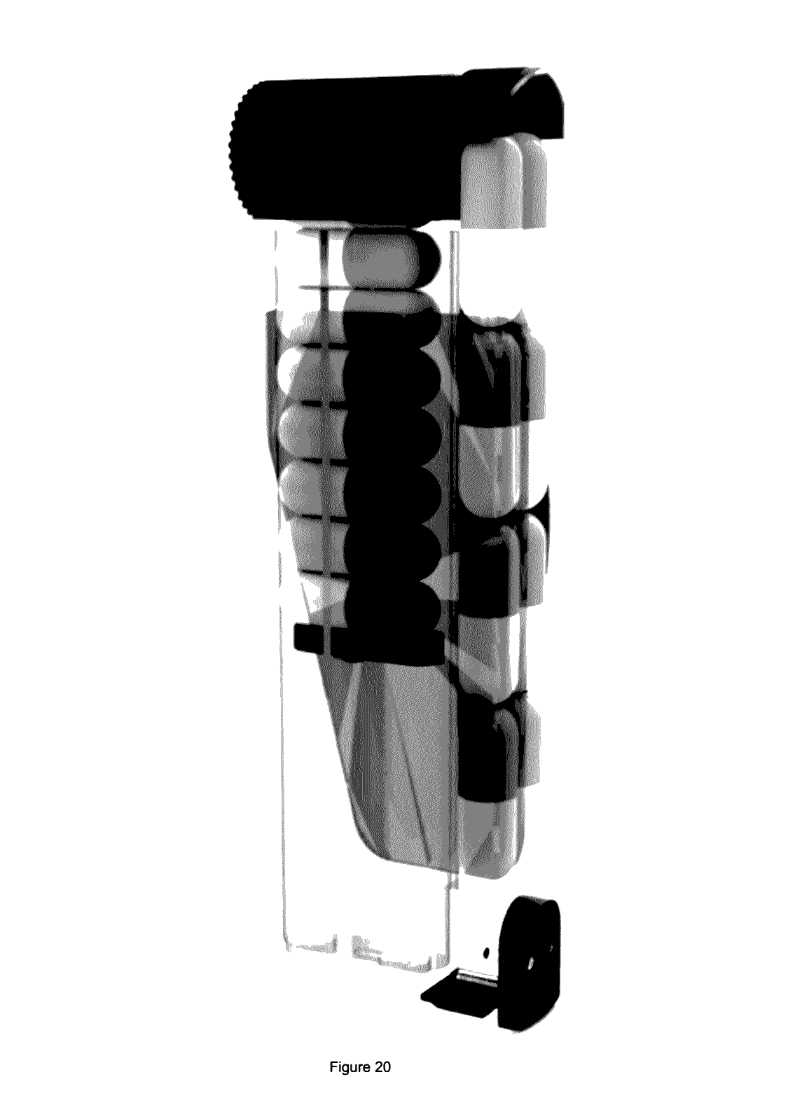

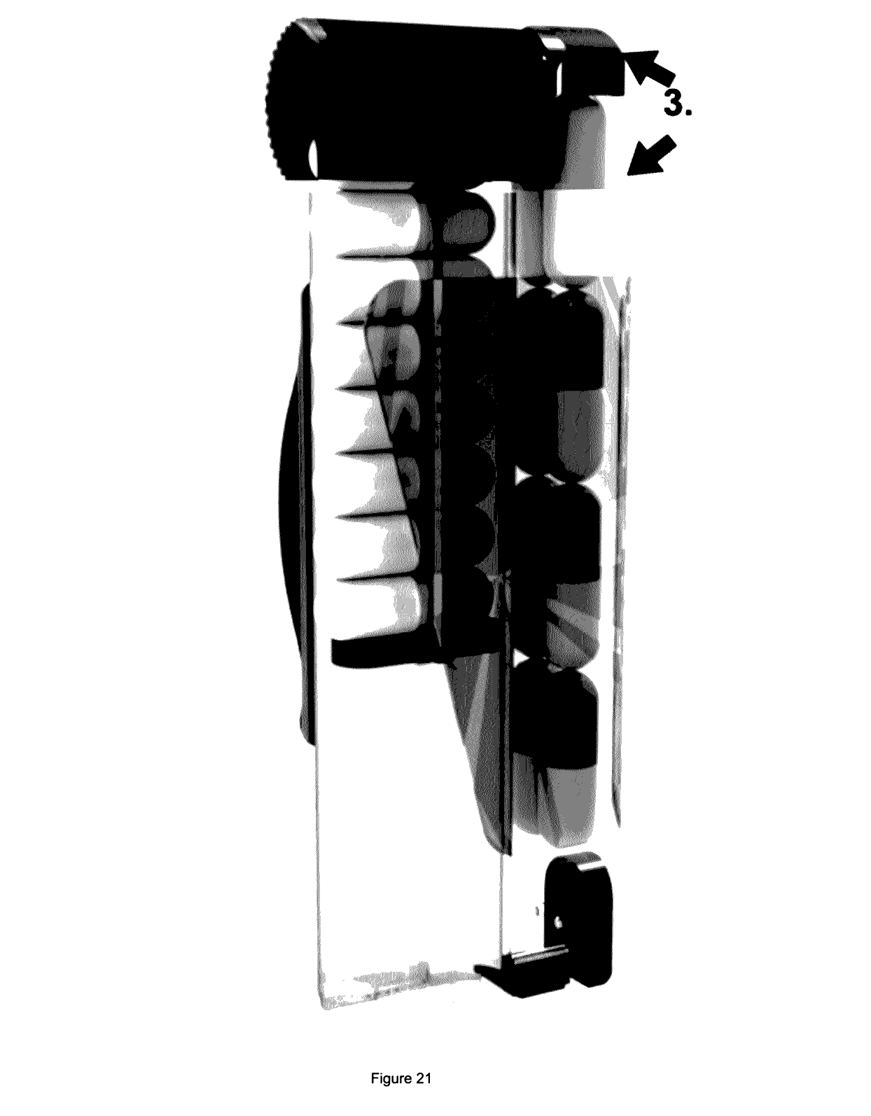

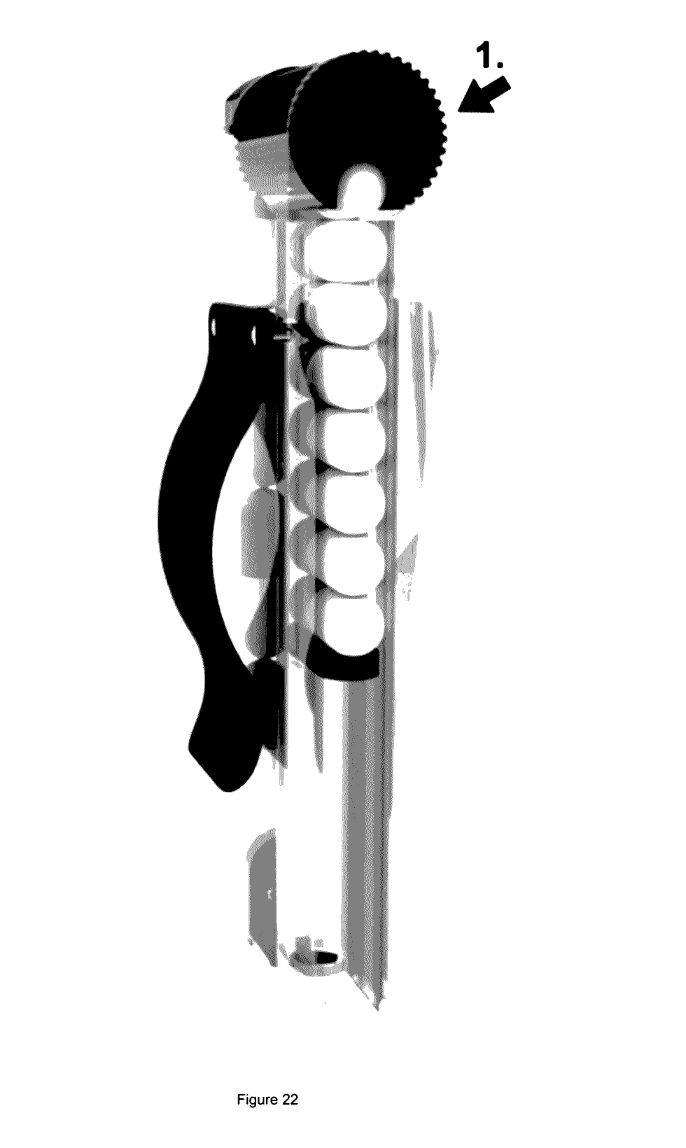

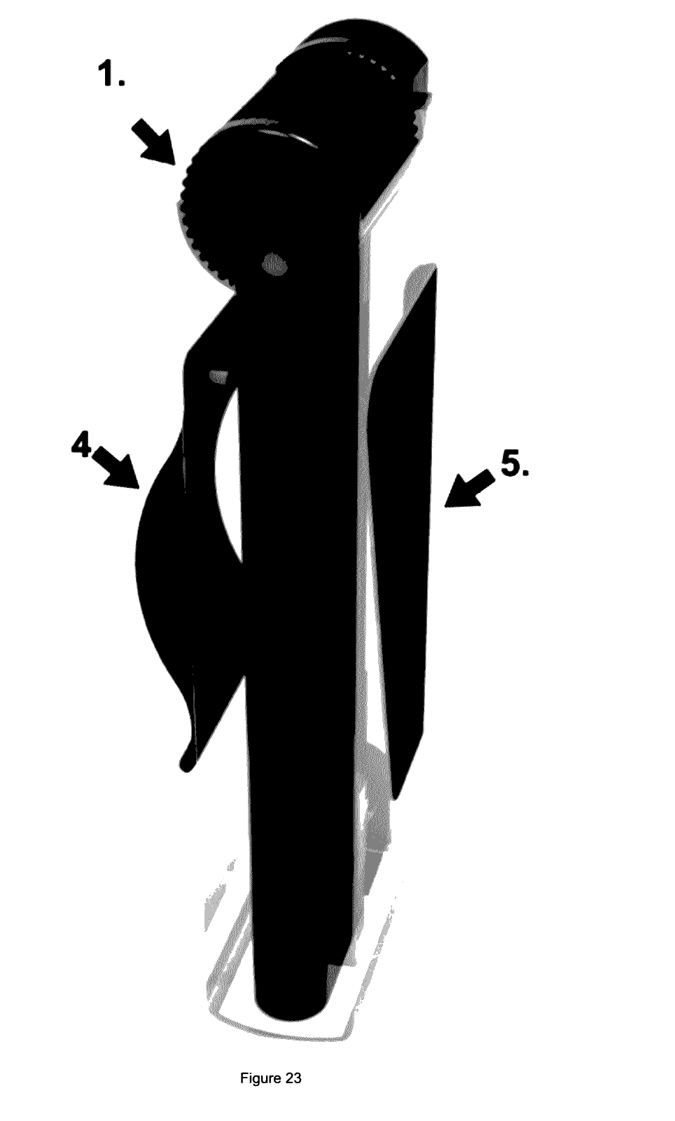

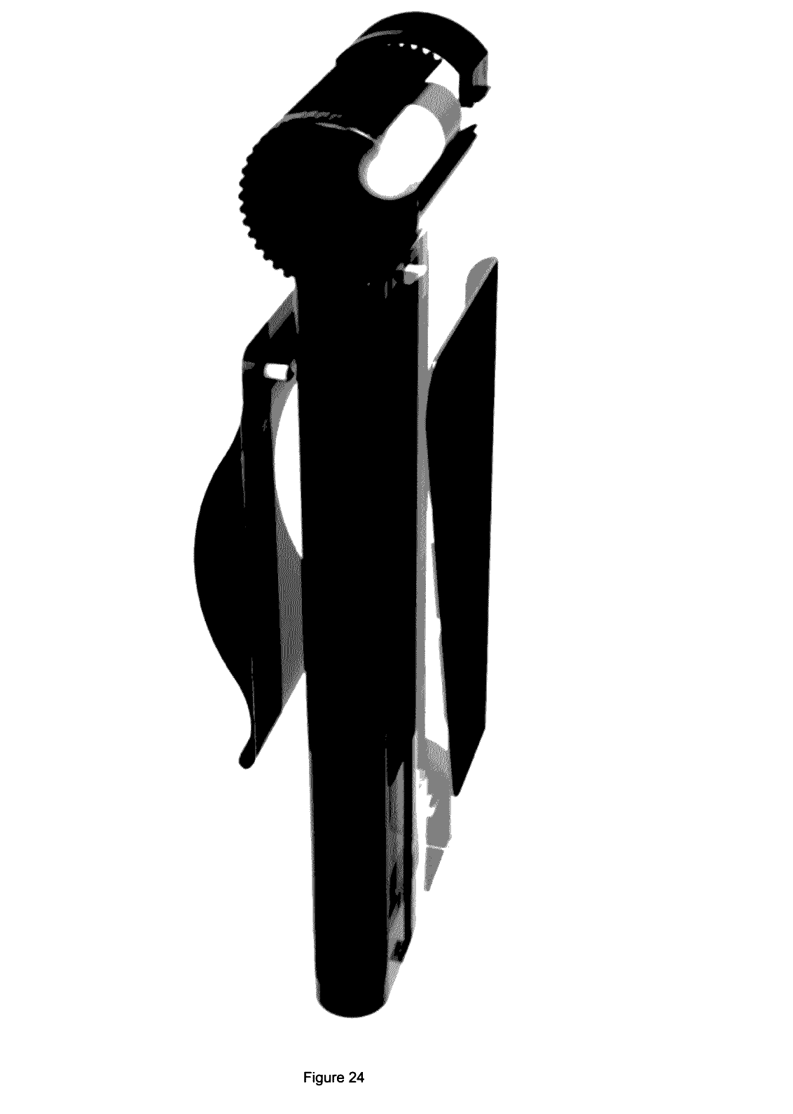

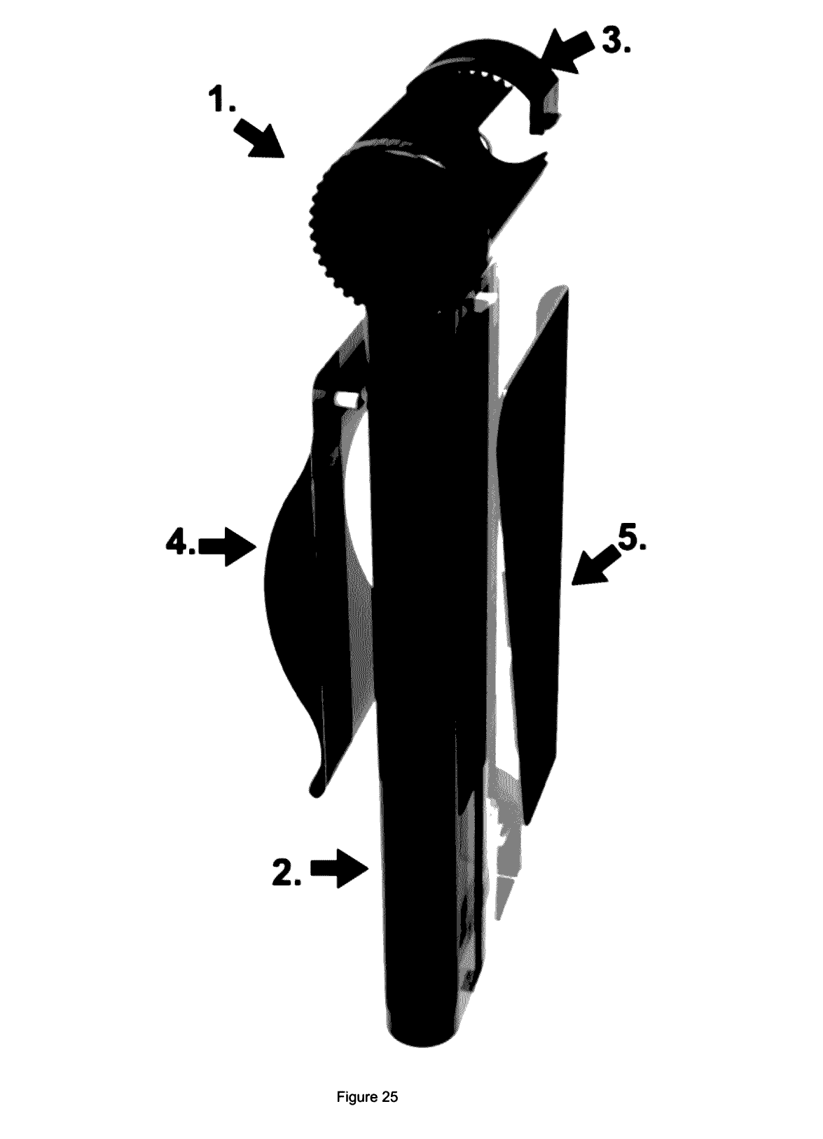

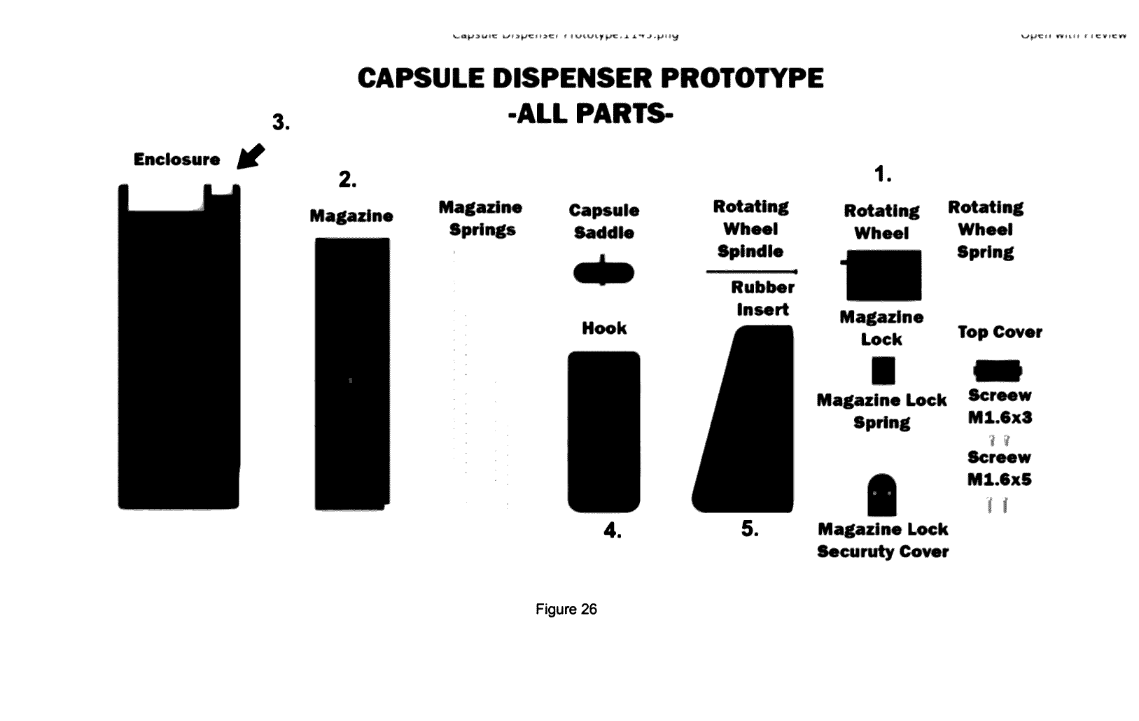

### DESCRIPTION OF THE EMBODIMENTS

Reference will now be made in detail to the present exemplary embodiments of the invention, examples of which are illustrated in the accompanying drawings.

Embodiments of the present invention allow a user to obtain a capsule with one hand. Users (or consumers) can organize capsules in the order he/she chooses depending on the need for electrolyte, anti-cramping, or any other desired capsule supplement. Dispenser embodiments of the present invention only dispense one deliverable, such as a capsule, at a time, solving the consumer's problem quickly on a bike, while running, etc. Embodiments of the present invention also may have a clip-on or Velcro option, allowing it to be attached to wristbands, armbands, bicycles, or any other desired area or surface in proximity to the user. In endurance sports, this device will eliminate time loss, as there is never a need to stop. Embodiments of the present invention may have a water resistant design and can be modified to accommodate different capsule sizes. Variations other embodiments of the present invention may include a waterproofed model for use in aquatic sports and a model with a timer, a buzzer, and/or a biometric and environmental functionality to assist the consumer with his/her pace of consumption.

Various embodiments of the present invention may include at least the following components or subsets thereof, the numbering below corresponding to the annotated figures filed herewith:
1) A spring-loaded rotating cylinder/wheel that dispenses one capsule at a time by rotating it.
2) A spring-loaded magazine that may be slid into a housing and feed capsules to the cylinder for dispensing.
3) A storage chamber/compartment where extra capsules can be stored.
4) A clip/hook so that the dispenser can be attached to the body (waistband, armband etc.) or other desired storage location.
5) A Rubber (or other desired material) insert/grip.
6) A flip top/water shield.
7) A timer/buzzer/indicator of pace of consumption or of pace of any other desired parameter.
8) A frame/enclosure (or housing) that incorporates component 1-7.

The spring-loaded rotating cylinder/wheel 1 may pick up one capsule at a time. It may be operated by rotating the spring-loaded cylinder in either direction with the thumb or other desired actuator to expose a capsule that may be consumed. The spring-loaded rotating cylinder/wheel 1 can be modified to accommodate each variation of capsule in the market.

The spring-loaded magazine 2 may have a platform that pushes capsules upward and keeps tension until the last capsule in the device is dispensed. This component can be removed from the frame by releasing a spring-loaded locking mechanism. When the magazine is removed, the platform that advances the capsules can be fully depressed and latched to allow capsule loading. The magazine may allow the consumer to organize various capsules according to their desired pattern of consumption.

The storage chamber/compartment 3 may be opened with the thumbnail or any other desired portion of the anatomy or item. This part of the dispenser may be to hold extra capsules.

The clip-hook/Velcro 4 may be used to fasten to a garment, a belt, a pocket or any other desired area.

The rubber (or other desired material) Insert/Grip 5 may be used to prevent from the dispenser from slipping out of sweaty hands.

The flip top/water shield 6 may be used to protect the dispenser from moisture. It may be flipped open with a thumb or any other desired part of the anatomy or item.

The timer/buzzer/indicator 7 may be used to let the user know when it is time to consume the next capsule or may be used to indicate any other desired parameter to the user.

The dispenser frame 8 houses component 1-7.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system, comprising:
a housing;
a magazine slideably retained within the housing, said magazine for retaining provided capsules for selective dispensing from the housing;
a timer for counting down a predetermined time period; and
an indicator for signifying to a user when the predetermined time period has run, indicating that it is time to dispense and consume one of the provided capsules.

2. A method, comprising:
providing a housing;
providing a magazine slideably retained within the housing, said magazine for retaining provided capsules for selective dispensing from the housing;
counting down a predetermined time period; and
signifying to a user when the predetermined time period has run, indicating that it is time to dispense and consume one of the provided capsules.
